(19) United States
(12) Patent Application Publication
(10) Pub. No.: US 2006/0080456 A1
(43) Pub. Date: Apr. 13, 2006

(54) Device and method of integrating and executing multimedia streaming service and application streaming service

(76) Inventors: Sung Jin Hur, Taejon (KR); Ki Hyuk Nam, Taejon (KR); Ji Soo Kim, Taejon (KR); June Kim, Taejon (KR); Won Young Kim, Taejon (KR); Jeong Min Shim, Taejon (KR); Wan Choi, Taejon (KR)

Correspondence Address: MAYER, BROWN, ROWE & MAW LLP, 1909 K STREET, N.W., WASHINGTON, DC, 20006, US

(21) Appl. No.: 11/017,057

(22) Filed: Dec. 21, 2004

(30) Foreign Application Priority Data
Oct. 13, 2004 (KR) 2004-81889

(51) Int. Cl. G06F 15/16

(52) U.S. Cl. 709/231

(57) ABSTRACT

The present invention provides a device of integrating and executing a multimedia streaming service and an application streaming service, the device including: a user interface for executing and displaying multimedia data or application data to a user, and receiving a control signal from a user; a multimedia streaming control module for generating a multimedia streaming session to receive a multimedia streaming data, and executing the received multimedia streaming data through the user interface; an application streaming control module for generating an application streaming session to receive an application streaming data, and executing the received application streaming data through the user interface; and a control module for generating the multimedia streaming control module and the application streaming control module, and synchronizing the multimedia streaming session and the application streaming session.

### BACKGROUND OF THE INVENITON

1. Field of the Invention

The present invention relates to a device of integrating and executing a multimedia streaming service and an application streaming service to provide a new concept of streaming service.

2. Description of the Related Art

Streaming service allows a receiving side to concurrently receive and reproduce or process data without waiting until data is completely received. The streaming service is mainly classified into a multimedia streaming service and an application streaming service depending on a characteristic of data. Since the multimedia streaming service can concurrently receive and reproduce multimedia contents, it can provide a real time multimedia reproduction service. For this multimedia reproduction service, a predetermined transmission bandwidth should be secured for a total time for which the multimedia reproduction service is provided. Actually, a loss of data is necessarily generated due to a traffic overload on a network. Accordingly, a variety of technologies have been developed to minimize a degradation of image and voice data despite of the loss of data. Whereas, since an error or the loss of data occurring at the time of data transmission makes it impossible to execute an application service in an application service streaming service provided by an Application Service Provider (ASP), a critical result is caused. Accordingly, there is a difference in that an error of the data transmission is strictly processed.

FIG. 1 illustrates a process of exchanging a control message and a multimedia streaming data between a streaming server for transmitting the multimedia streaming data and a client for receiving and processing the multimedia streaming data.

Referring to FIG. 1, a RTSP module of the streaming server receives a Real Time Streaming Protocol (RTSP) control message for setting a session connection with a server so that the client connected to the Internet receives multimedia data. If the setting of the session connection is completed between the client and the streaming server, the client transmits the RTSP control message requiring the transmission of the multimedia data, to the RTSP module of the streaming server. The RSTP module transmits the received RTSP control message to a server main module. The server main module reads and transmits the multimedia data stored in a file system, to process a corresponding message. During the transmission, the client can transmit to the streaming server the RTSP control message for stopping the transmission and resuming the stopped transmission. If all of the multimedia data are completely transmitted, the client transmits the RTSP control message requesting a release of the session connection to the RTSP module of the streaming server. If the RTSP module transmits the received RTSP control message to the server main module, the streaming server releases a server resource for securing the transmission of the multimedia data such as the file system, and instructs a Real-time Transport Protocol module to stop the transmission and then transmits a final result related to the request for the release of the session connection to the client through the RTSP module to terminate a session.

FIG. 2 illustrates a process of exchanging a control message and an application streaming data between a streaming server for transmitting the application streaming data and a client for receiving and processing the application streaming data.

Referring to FIG. 2, the client receives a necessary application program execution code from the server and executes the received application program execution code in a streaming way without installing an application program. For this, in case where the client requires an execution code to which the streaming service is not yet provided from the sever in relation to the executing of the application program, the client requests the streaming service of the corresponding execution code, and the server searches an execution code portion, which is requested by the client, in a database having the application service execution code, to transmit the corresponding portion of the execution code to the client so that the client can execute the corresponding application program as if the corresponding application program is installed at a local disc of the client.

Due to the above-described difference, a multimedia streaming service and an application streaming service have been treated as completely independent business fields having different concrete platform technologies despite common features of the streaming services. However, in case where the multimedia streaming service and the application streaming service are integrated with each other, the multimedia streaming service and the application streaming service can be reproduced at the same order or in a sequential order depending on a user's response, and a new concept of streaming service can be provided to the users through a mutual interaction between the multimedia data and the application program. Accordingly, the need for a method of integrating and executing the multimedia streaming service and the application streaming service is being raised.

### SUMMARY OF THE INVENTION

Accordingly, the present invention is directed to a device and method of integrating and executing a multimedia streaming service and an application streaming service, which substantially obviate one or more problems due to limitations and disadvantages of the related art.

It is an object of the present invention to provide a device and method of integrating and executing a multimedia streaming service and an application streaming service, thereby easily performing an interaction with the user, and improving a degree of user's concentration on the streaming service.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a device of integrating and executing a multimedia streaming service and an application streaming service, the device including: a user interface for executing and displaying multimedia data or application data to a user, and receiving a control signal from a user; a multimedia streaming control module for generating a multimedia streaming session to receive a multimedia streaming data, and executing the received multimedia streaming data through the user interface; an application streaming control module for generating an application streaming session to receive an application streaming data, and executing the received application streaming data through the user interface; and a control module for generating the multimedia streaming control module and the application streaming control module, and synchronizing the multimedia streaming session and the application streaming session.

In another aspect of the present invention, there is provided a method of integrating and executing a multimedia streaming service and an application streaming service, the method including the steps of: generating a multimedia streaming control module when the multimedia streaming service is requested, and generating an application streaming control module when the multimedia streaming service is requested; generating a multimedia streaming session in the generated multimedia streaming control module to receive a multimedia streaming data having a control code from a multimedia streaming server, and generating an application streaming session in the generated application streaming control module to receive an application streaming data having a control code from an application streaming server; analyzing the control codes contained in the received streaming data to determine whether or not synchronization between the multimedia streaming service and the application streaming service is required, and in case where the synchronization is required, temporarily stopping the streaming services; synchronizing the multimedia streaming service with the application streaming service; and resuming the temporarily stopped streaming services.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a view illustrating a conventional process of transmitting a multimedia streaming data;

FIG. 2 is a view illustrating a conventional process of transmitting an application service streaming data;

FIG. 3 is a schematic view illustrating a relation between a device of integrating and executing a multimedia streaming service and an application streaming service, and a streaming server according to the present invention;

FIG. 4 is a schematic view illustrating a construction of a device of integrating and executing a multimedia streaming service and an application streaming service according to the present invention; and

FIG. 5 is a flowchart illustrating a method of integrating and executing a multimedia streaming service and an application streaming service according to the present invention.

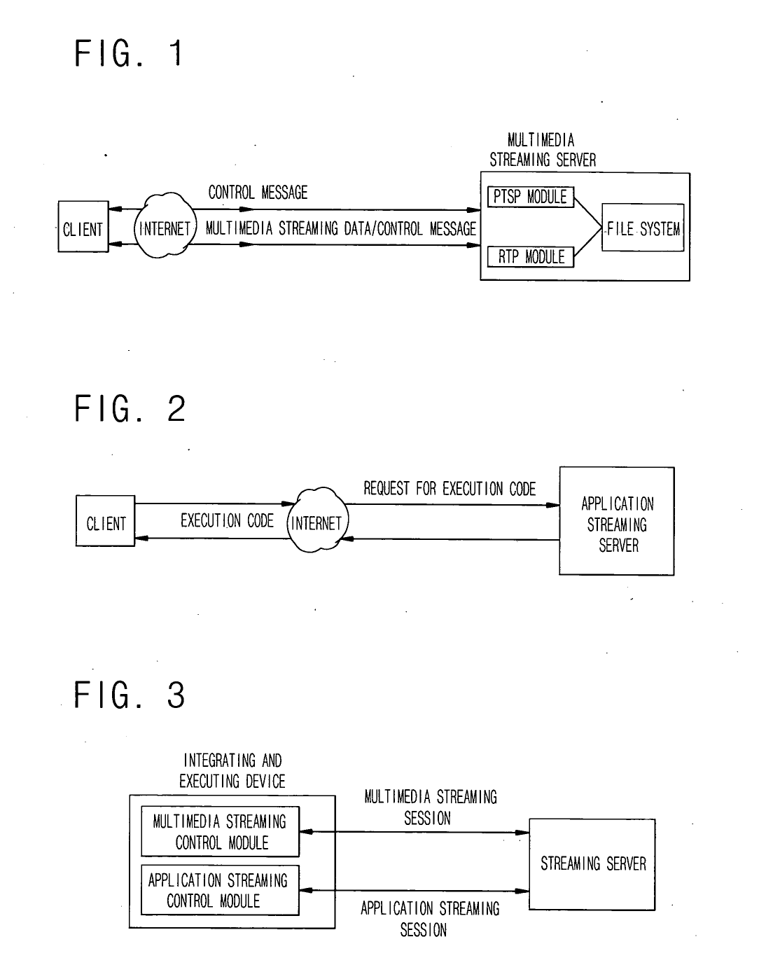

### DETAILED DESCRIPTION OF THE INVENTION

Reference will now be made in detail to the preferred embodiments of the present invention, examples of which are illustrated in the accompanying drawings.

FIG. 3 is a schematic view illustrating a relation between a device of integrating and executing a multimedia streaming service and an application streaming service, and a streaming server according to the present invention.

The integrating and executing device includes a multimedia streaming control module and an application service streaming control module. The integrating and executing device respectively generates, maintains and manages an application service streaming session and a multimedia streaming session through the multimedia streaming control module and the application service streaming control module, and controls and manages an execution code necessary for receiving a multimedia data and application service execution code from a streaming server. The streaming server can be classified into a multimedia streaming server and an application streaming server. The multimedia streaming server provides the multimedia streaming service, and the application streaming server provides the application streaming service. However, FIG. 3 illustrates the streaming server for transmitting the multimedia streaming data and the application streaming data so that the transmitted streaming data are synchronized and executed at a receiving side.

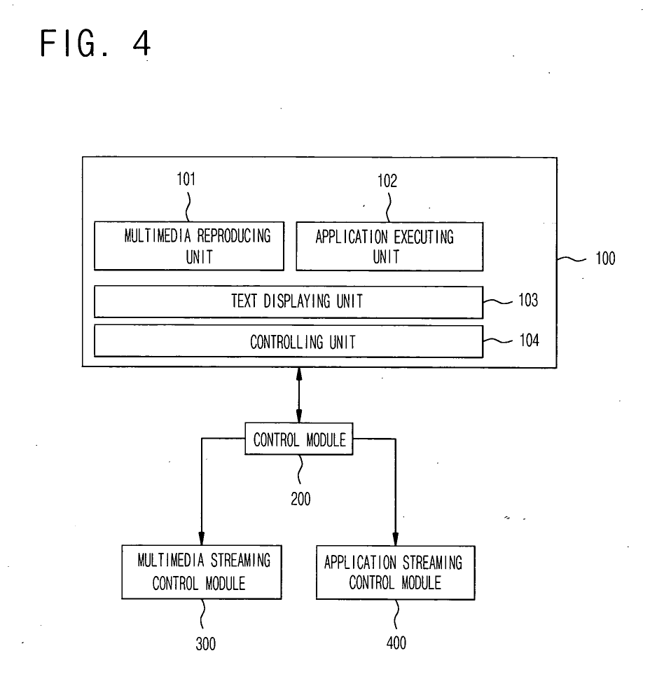

FIG. 4 is a schematic view illustrating a construction of the device of integrating and executing the multimedia streaming service and the application streaming service according to the present invention.

Referring to FIG. 4, the integrating and executing device includes a user interface 100 for executing and displaying multimedia data or application data for a user, and receiving a control signal from the user; a multimedia streaming control module 300 for receiving a multimedia streaming data to reproduce the received multimedia streaming data through the user interface 100; an application streaming control module 400 for receiving an application streaming data to reproduce the received application streaming data through the user interface 100; and a control module 200 for synchronizing the multimedia streaming control module 300 and the application streaming control module 400.

The user interface 100 includes a multimedia reproducing unit 101, a text displaying unit 103, an application executing unit 102 and a controlling unit 104. The multimedia reproducing unit 101 reproduces and displays the multimedia streaming data on a screen. The application executing unit 102 executes the application streaming data to perform an application program. The text displaying unit 103 displays a text, which is required when the multimedia streaming data or the application streaming data is executed. Additionally, the controlling unit 104 generates the control signal, which is required to execute the multimedia data or the application program, in response to an event such as user's clicking of a mouse or pressing of a keyboard.

The multimedia streaming control module 300 generates the multimedia streaming session to receive the multimedia data from the multi streaming server and reproduce the received multimedia data through the user interface 100.

The application streaming control module 400 generates the application streaming session to receive the application data from the application streaming server and reproduce the received application data through the user interface 100.

The control module 200 controls and manages the multimedia streaming control module 300 and the application streaming control module 400 depending on the control signal, which is received from the user through the user interface 100. The control module 200 synchronizes the multimedia streaming session with the application streaming session. Such synchronization is performed by using a control code of a Synchronized Multimedia Integration Language (SMIL) standard. The SMIL standard has a regulation for the multimedia streaming data, but does not have a regulation for the application streaming data. Accordingly, a tag for the application streaming service not mentioned in the SMIL standard is added to perform the synchronization. Since the SMIL is based on an extensible Markup Language (XML), the synchronization can be performed just only by the addition of the tag required for the application streaming service.

In case where the synchronization is required at the multimedia streaming service or the application streaming service, that is, in case where the multimedia streaming data and the application streaming data are concurrently received and one of them is selectively executed, or the application streaming data is executed depending on an executed result of the multimedia streaming data or vice versa, the control code of the SMIL standard is received from the streaming server to perform the synchronization.

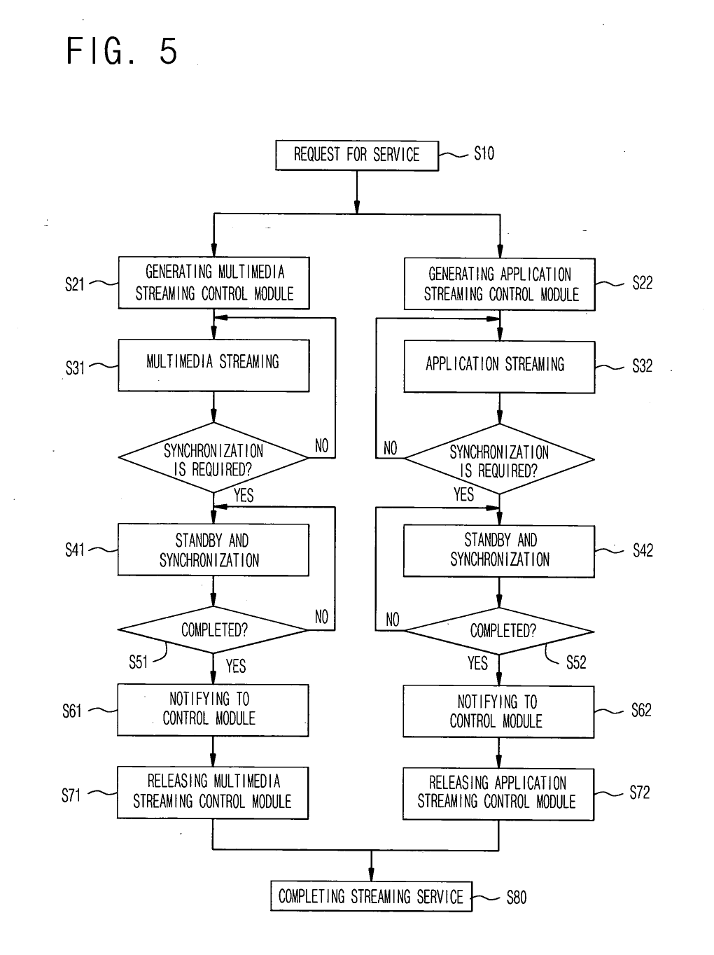

FIG. 5 is a flowchart illustrating a method of integrating and executing the multimedia streaming service and the application streaming service according to the present invention.

If the user requests the multimedia streaming service or the application streaming service through the user interface 100 (S10), the control module 200 generates the multimedia streaming control module when the user requests the multimedia streaming service (S21), and generates the application streaming control module when the user requests the application streaming service (S22). The generated multimedia streaming control module generates the multimedia streaming session to receive the multimedia streaming data from the multimedia streaming server (S31). The generated application streaming control module generates the application streaming session to receive the application streaming data from the application streaming server (S32). It is determined whether or not the synchronization is required between the multimedia streaming service and the application streaming service. In case where it is determined that the synchronization is required, the streaming services are temporarily stopped (S41 and S42). In other words, in case where the multimedia streaming server and the application streaming server are identical with each other, or in case where the multimedia streaming data and the application streaming data are concurrently received and one of them is selectively executed, it is required to perform the synchronization. For this, the synchronization is performed using the SMIL as described above. If the synchronization is performed, it is determined whether or not the streaming services are completed. If the streaming services are not yet completed, the corresponding streaming services are resumed (S51 and S52). If the streaming services are completed and the completion of the corresponding streaming services is notified to the control module (S61 and S62), the control module releases the streaming control modules with the services being completed (S71 and S72) to terminate a procedure (S80).

In the above-described integrating and executing device and method, a motion picture for a usage manual of the application program is reproduced to allow the user to fully acknowledge the usage manual and then the application program is at once executed by using the application streaming service, or the application streaming service is converted into a motion picture streaming service to display an on-line help if the on-line help is requested at the time of the application streaming service.

Accordingly, the present invention has an excellent advantage in that an interaction is easily performed with the user, and a degree of user's concentration on the streaming service is improved in comparison with the case where the application streaming service and the multimedia streaming service are separately used.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A device of integrating and executing a multimedia streaming service and an application streaming service, the device comprising:
a user interface for executing and displaying multimedia data or application data to a user, and receiving a control signal from a user;
a multimedia streaming control module for generating a multimedia streaming session to receive a multimedia streaming data, and executing the received multimedia streaming data through the user interface;
an application streaming control module for generating an application streaming session to receive an application streaming data, and executing the received application streaming data through the user interface; and
a control module for generating the multimedia streaming control module and the application streaming control module, and synchronizing the multimedia streaming session with the application streaming session.

2. The device of claim 1, wherein the user interface comprises:
a multimedia reproducing unit for executing the multimedia streaming data;
an application executing unit for executing the application streaming data;
a text displaying unit for displaying a text when the multimedia reproducing unit and the application executing unit execute the multimedia streaming data and the application streaming data; and
a controlling unit for receiving the control signal from the user.

3. The device of claim 1, wherein the control module receives a control code of a SMIL (Synchronized Multimedia Integration Language) standard from the streaming server for transmitting the multimedia streaming data and the application streaming data to perform synchronization depending on the control code.

4. The device of claim 3, wherein the control code has a tag for the application streaming service, the tag being added to a SMIL standard code.

5. A method of integrating and executing a multimedia streaming service and an application streaming service, the method comprising the steps of:
generating a multimedia streaming control module when the multimedia streaming service is requested, and generating an application streaming control module when the multimedia streaming service is requested;
generating a multimedia streaming session in the generated multimedia streaming control module to receive a multimedia streaming data having a control code from a multimedia streaming server, and generating an application streaming session in the generated application streaming control module to receive an application streaming data having a control code from an application streaming server;
analyzing the control codes contained in the received streaming data to determine whether or not synchronization between the multimedia streaming service and the application streaming service is required, and in case where the synchronization is required, temporarily stopping the streaming services;
synchronizing the multimedia streaming service with the application streaming service; and
resuming the temporarily stopped streaming services.

6. The method of claim 5, wherein the received control code has a tag for the application streaming service, the tag being added to a SMIL standard code.

7. The method of claim 5, wherein the synchronization is performed by selectively executing the application streaming data and the multimedia streaming data depending on a user's response.
